(19) United States
(12) Patent Application Publication
(10) Pub. No.: US 2014/0295808 A1
(43) Pub. Date: Oct. 2, 2014

(54) Method And Apparatus For Automatically Prioritizing Contact List Information Using Data Correlation

(71) Applicant: APPLE INC., Cupertino, CA (US)

(72) Inventors: Colin M. Ely, Cupertino, CA (US); Erik G. De Jong, San Francisco, CA (US)

(73) Assignee: Apple Inc., Cupertino, CA (US)

(21) Appl. No.: 13/855,361

(22) Filed: Apr. 2, 2013

(51) Int. Cl. H04M 1/2745

(52) U.S. Cl. CPC H04M 1/274583
USPC 455/414.1

(57) ABSTRACT

A processor-based personal electronic device (such as a smartphone) is programmed to automatically prioritize a contact list (“address book” or “phone book”) based on one or more factors. The factors may include the frequency and/or recency of calls to or from a particular contact, the location of the user, the location of a particular contact, the time of day, the day of the week, and historical data (such as a user's daily pattern of calls, the recency of selection of the contact, the recency of an in-coming call from the contact, the frequency of in-coming calls from the contact, and the recency of non-telephonic communication via the device with the contact.).

### CROSS-REFERENCE TO RELATED APPLICATIONS

None

### STATEMENT REGARDING FEDERALLY SPONSORED RESEARCH OR DEVELOPMENT

Not Applicable

### BACKGROUND OF THE INVENTION

1. Field of the Invention

This invention relates to personal electronic devices. More particularly, it relates to the contact list functions of personal electronic devices such as smartphones.

2. Description of the Related Art including information disclosed under 37 CFR 1.97 and 1.98

A smartphone is a mobile phone built on a mobile operating system and having advanced computing capability and connectivity. The first smartphones combined the functions of a personal digital assistant (PDA) with a mobile phone. Later models added the functionality of portable media players, compact digital cameras, pocket video cameras, and GPS navigation units to form one multi-use device. Many current smartphones also include high-resolution touchscreens for input and web browsers that display standard web pages as well as mobile-optimized sites. High-speed data access may be provided by Wi-Fi and/or Mobile Broadband.

Many personal electronic devices (and smartphones in particular) include a contact list function which displays selected personal data from a database concerning individuals and/or businesses and other such entities. Typically, contact data includes name, mailing address, phone number(s), e-mail address, company, job title, and sometimes an image for each entry. A contact entry may be assigned to one or more groups of contacts. For example, certain contacts may be assigned to a group designated “babysitters.”

Most often, contact lists are organized alphabetically by name. As a contact list grows in the number of individual records, it becomes more difficult and time consuming for the user to find the desired contact information simply on the basis of the first letter(s) of the desired contact's name. In practice, it has been observed that contact lists are rarely trimmed to remove outdated or seldom-used entries. Moreover, with the advent of cloud-based computing and data network connections for personal electronic devices, contact lists can grow quickly in size as users share their contact lists with others.

So-called “cloud” computing services allow users of various networked electronic devices to store data (including contact data) on a remote server. Contact information may therefore be easily shared among users of the service by allowing access to their stored contact data.

With iCloud™ electronic storage services, a user's entire address book may be on whichever device he or she is using. Say a user adds someone to Contacts on his iPhone, iPad, or iPod touch device. iCloud automatically pushes the new contact to Contacts or Address Book on his desktop PC. In this way, a portable device user does not have to connect the device to his or her computer to keep track of all contacts.

### Location Sensors

Currently available smartphones have several means for determining their location.

Satellite-based navigation systems may be incorporated into a smartphone. A satellite navigation system with global coverage if often termed a global navigation satellite system or GNSS.

Assisted GPS, generally abbreviated as A-GPS or aGPS, is a system that can under certain conditions improve the startup performance, or time-to-first-fix (TTFF), of a GPS satellite-based positioning system. It is used extensively with GPS-capable cellular phones as its development was accelerated by the Federal Communication Commission's 911 requirement to make the location of a cell phone available to emergency call dispatchers.

Many mobile phones combine A-GPS and other location services including Wi-Fi Positioning System and cell-site multilateration and sometimes a hybrid positioning system.

Global navigation satellite systems are generally not suitable to establish indoor locations, since microwaves are attenuated and scattered by roofs, walls and other objects. However, in order to obtain positioning information everywhere, integration between GPS and indoor positioning methods can be made.

### Wi-Fi Positioning

Wi-Fi-based positioning system (WPS) is used where GPS is inadequate due to various causes including multipath and signal blockage indoors. Such systems include indoor positioning systems. Wi-Fi positioning takes advantage of the rapid growth in the early 21st century of wireless access points in urban areas. There are currently a number of commercial providers of this type of service.

### Cellular Location

Mobile phone tracking refers to attaining the current position of a mobile phone, stationary or moving. Localization may be accomplished either via multilateration of radio signals between (several) radio towers of the network and the phone, or simply via GPS. To locate the phone using multilateration of radio signals, it must emit at least the roaming signal to contact the next nearby antenna tower, but the process does not require an active call.

Mobile positioning, which includes location-based service that discloses the actual coordinates of a mobile phone, is a technology used by telecommunication companies to approximate where a mobile phone is (temporarily) located.

Location tracking and reporting services are available to users of location-enabled personal electronic devices. Subscribers may allow their device to periodically report its location to a remote service. The reporting may be accomplished via a telecommunications network. The user may allow other, pre-selected persons to access the current location of their device stored on the remote server. Such services enable various “find my friends” type application programs.

### BRIEF SUMMARY OF THE INVENTION

A processor-based personal electronic device (such as a smartphone) is programmed to automatically prioritize a contact list (“address book” or “phone book”) based on one or more factors. The factors may include the frequency and/or recency of calls to or from a particular contact, the location of the user, the location of a particular contact, the date and/or time of day, and historical data (such as a user's daily or weekly pattern of calls).

In one particular representative embodiment, certain contacts are “hidden”—i.e., not immediately displayed—when the user not at a particular location. For example, if the user historical data indicates that certain numbers are called only when the user is at a certain location (e.g., a work location), those numbers may be “hidden” when the user is away from that particular location. This process may be refined by adding date and time information. For example, the historical data may show that calls to (and from) certain work colleagues are (almost) always performed on weekdays between the hours of 8:00 a.m. and 6:00 p.m. If the user is not at his or her work location (i.e., the most frequent location of the user on weekdays between the hours of 8:00 a.m. and 6:00 p.m.), the system may be programmed to “hide” the contact information of work colleagues when the display of contact information is (initially) requested. In this way, the displayed contact list may be reduced to manageable size and the chances of an inadvertent (and perhaps inappropriate) contact selection from a presented list of contacts may also be reduced.

### BRIEF DESCRIPTION OF THE SEVERAL VIEWS OF THE DRAWING(S)

FIG. 1 is a block diagram of a processor-based device

### DETAILED DESCRIPTION OF THE INVENTION

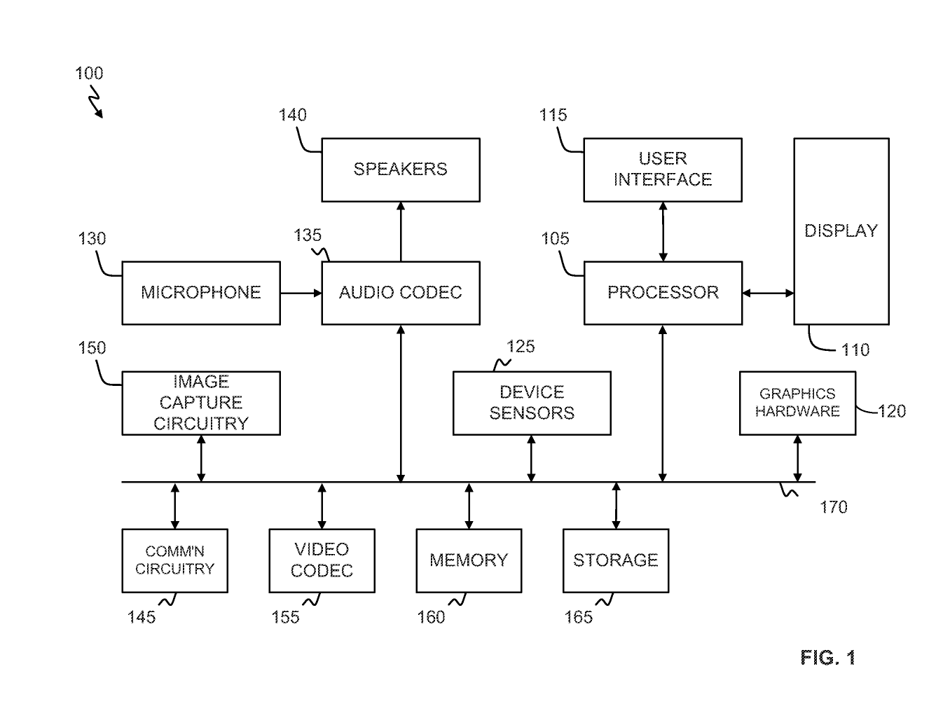

Referring to FIG. 1, a simplified functional block diagram of illustrative electronic device 100 is shown according to one embodiment. Electronic device 100 could, for example, be a smartphone, personal media device, portable camera, or a tablet, notebook or desktop computer system. As shown, electronic device 100 may include processor 105, display 110, user interface 115, graphics hardware 120, device sensors 125 (e.g., proximity sensor/ambient light sensor, accelerometer and/or gyroscope), microphone 130, audio codec(s) 135, speaker(s) 140, communications circuitry 145, image capture circuit or unit 150, video codec(s) 155, memory 160, storage 165, and communications bus 170.

Processor 105 may execute instructions necessary to carry out or control the operation of many functions performed by device 100 (e.g., such as the processing of data obtained from device sensors 125). Processor 105 may, for instance, drive display 110 and receive user input from user interface 115. User interface 115 can take a variety of forms, such as a button, keypad, dial, a click wheel, keyboard, display screen and/or a touch screen. Processor 105 may be a system-on-chip such as those found in mobile devices and include one or more dedicated graphics processing units (GPUs). Processor 105 may be based on reduced instruction-set computer (RISC) or complex instruction-set computer (CISC) architectures or any other suitable architecture and may include one or more processing cores. Graphics hardware 120 may be special purpose computational hardware for processing graphics and/or assisting processor 105 perform computational tasks. In one embodiment, graphics hardware 120 may include one or more programmable graphics processing units (GPUs).

Image capture circuitry 150 may capture still and video images that may be processed to generate images. Output from image capture circuitry 150 may be processed, at least in part, by video codec(s) 155 and/or processor 105 and/or graphics hardware 120, and/or a dedicated image processing unit incorporated within circuitry 150. Images so captured may be stored in memory 160 and/or storage 165. Memory 160 may include one or more different types of media used by processor 105, graphics hardware 120, and image capture circuitry 150 to perform device functions. For example, memory 160 may include memory cache, read-only memory (ROM), and/or random access memory (RAM). Storage 165 may store media (e.g., audio, image and video files), computer program instructions or software, preference information, device profile information, and any other suitable data. Storage 165 may include one more non-transitory storage mediums including, for example, magnetic disks (fixed, floppy, and removable) and tape, optical media such as CD-ROMs and digital video disks (DVDs), and semiconductor memory devices such as Electrically Programmable Read-Only Memory (EPROM), and Electrically Erasable Programmable Read-Only Memory (EEPROM). Memory 160 and storage 165 may be used to retain computer program instructions or code organized into one or more modules and written in any desired computer programming language. When executed by, for example, processor 105 such computer program code may implement one or more of the methods described herein.

An electronic device such as device 100 may receive inputs from on-board device sensors 125 which sensors may be of the types described, above—e.g., location sensors.

The invention may best be understood by reference to the following examples and exemplary embodiment(s) illustrated in the drawing figures.

### EXAMPLE 1

By way of example, consider a case wherein device 100 is a smartphone having an application program for an “address book” or “contacts” that, upon user request, displays an alphabetical list of persons and/or entities together with typical contact information such as company name, job title, telephone number(s), e-mail address, work address, home address, IM address, and the like. The displayed list may include a scroll bar for moving through the list of contacts and/or a depiction of the alphabet wherein selection of a letter by a pointing device (or touchscreen) causes the display to shift to a listing of those contacts whose name begins with the selected letter. If the contact list is lengthy, a significant amount of scrolling by the user may be needed to reach the desired contact.

In a method according to the invention, however, the displayed contact list may be prioritized using historical data stored on the device (or in a data repository accessible by the device). The historical data may be call frequency to and/or from a specific contact on a certain day of the week and/or a certain time of day. Thus, on a certain day of the week and/or a certain time of day, a displayed contact list may give priority to those contacts who are more frequently selected by the user in that date/time “window.” By way of example, communication with a certain contact may occur much more frequently on weekdays and during normal working hours. When the user accesses his or her contacts during normal working hours on a weekday, that contact may be assigned a higher priority than when the user accesses his or her contacts on a weekend or outside of normal working hours.

The priority may take the form of a location higher in the list, a graphical enhancement or emphasis (e.g., bold typeface, background highlighting or the like) or any other suitable means. In one particular embodiment, contacts are prioritized by frequency of communication within a group consisting of names beginning with a certain letter. Thus, within the “M's,” a contact named “Mary” may be displayed above a contact named “Margaret” if Mary is more often contacted by the user than Margaret at that particular time of day and/or day of the week.

In certain embodiments, the historical data may be prioritized. For example, the priority given a certain contact may be weighted by the type of communication. A user may be more likely to need contact data for a contact he or she frequently contacts as opposed to a contact he or she frequently receives communications from. A prioritized contact list may then give higher priority to someone frequently contacted by the user than to an inbound caller (e-mail sender, etc.) whose calls or messages are of about the same frequency. Likewise, more recent communications to or from a particular contact may increase the priority of that contact.

In the same way, certain numbers or addresses within a contact listing may be given priority over lesser-used numbers or addresses for that same contact. For example, it may not be necessary to (initially) display a certain contact's fax number if his or her cell number is much more frequently called by the user of the device. A contact's office number may be prioritized over that person's home phone number if the office number is more frequently called. Likewise, a contact's IM address [or e-mail address] may be prioritized over his or her telephone number if communication by the user with that contact is more frequently by text than voice.

The display listing of prioritized contacts may include means for decreasing (and/or increasing) the level of prioritization. For example, a “show more” virtual button may be provided to allow the user to selectively display more contacts and/or more listings within a certain contact. If say a work number were needed during non-working hours, the user could disable that time-of-day filter by selecting the “show more” button.

It should be understood that lesser-used contact information need not be deleted from the data repository (underlying contact list), but rather a subset of that list may be initially displayed upon user request. If the desired contact information is not found in the displayed priority list (the subset list), the user may have the option of viewing the entire list. Alternatively, the user may selectively “dial back” the priority filter to progressively display a more inclusive list of contacts until the desired contact is found.

Other forms of communication may be used in the prioritization. For example, the contact information for the sender of a recently-received e-mail may be assigned a higher priority than it would otherwise have based on the expectation that the user may be likely to telephone that person in response.

### EXAMPLE 2

In this example, a smartphone (or other such personal electronic device) is programmed to display a contact list prioritized with reference to the user's current location. Historical call information stored on the device (or in a data repository accessible by the device) may indicate that certain contacts are more frequently called when the user is at a first location and other contacts are more frequently called when the user is at a second location. This data may be further refined by reference to time of day and/or day of week. For example, the first location may be the user's workplace which the user typically frequents on weekdays between the hours of 8:00 a.m. and 6:00 p.m. The second location may be the user's home which he or she frequents on weekends and weekday nights and evenings.

When the user accesses his or her contact list while at the first location (work) those contacts more frequently called from that location may be assigned higher priority than contacts less frequently called from that location (e.g., the contact list may preferentially show contact information for work colleagues as compared to social contacts). The priority may be further refined by time of day. For example, due to time zone differences, work calls from an east coast location to a west coast location may be more frequent in the afternoon hours of Eastern Time than in the morning hours and the call list may be prioritized accordingly.

Correspondingly, when the user is at home (second location) the contact list may preferentially show social and/or family contacts versus work-related contacts. It will be appreciated that the method of the present invention permits this distinction to be made without any indicating information in the contact information itself—i.e., it is not necessary for the user to categorize a particular contact as a “social contact” or a “work contact” (as by putting them in a subgroup or folder). Rather, the system uses location information and/or date and time information to correlate user location with call frequency.

### EXAMPLE 3

In another embodiment of the invention, the system may monitor the frequency of calls to a certain number dialed by the user using the keypad of the phone and prompt the user to add a contact for that number if one does not currently exist in the user's contact data.

In one particular embodiment, the user may be presented with a form having the frequently-dialed number already inserted and asked to enter at least the contact's name so that a new contact record may be created. Historical data about that number may then be associated with the contact. The historical data may include call frequency, call volume and call location. The system may distinguish between a number that is frequently called in a short period of time versus one that is called less frequently but over a longer period of time. In this way, temporarily frequent calls (such as to a certain hospital room) may be distinguished from calls more likely to be repeated in the future and thus more appropriate for inclusion in a contact list.

### EXAMPLE 4

In yet another example, the method of the invention may be used to temporarily “hide” one or more contacts so as to avoid the inadvertent selection of an inappropriate contact.

If the user historical data indicates that certain numbers are called only when the user is at a certain location (e.g., a work location), those numbers may be “hidden” when the user is away from that particular location (as opposed to merely being assigned a lower priority). This process may be refined by adding date and time information. For example, the historical data may show that calls to (and from) certain work colleagues are (almost) always performed on weekdays between the hours of 8:00 a.m. and 6:00 p.m. If the user is not at his or her work location (i.e., the most frequent location of the user on weekdays between the hours of 8:00 a.m. and 6:00 p.m.), the system may be programmed to “hide” the contact information of work colleagues when the display of contact information is (initially) requested. In this way, the displayed contact list may be reduced to manageable size and the chances of an inadvertent (and perhaps inappropriate) contact selection from a presented list of contacts may also be reduced. This removes the problem of having a frequently-called contact next to a contact that the user does not want to call.

In the same way, the work number of a certain contact may be temporarily “hidden” but not his or her home phone number when the user is away from the workplace and/or it is outside normal business hours.

In this context, “hidden” may mean not immediately included on the displayed contact list but still available to the user by deselecting the filtering function of the invention. Alternatively, additional contacts may be displayed (i.e., not “hidden”) if the user continues typing out additional letters of the contact's name. For example, the contact “Mary Smith” may be hidden if it is infrequently used in a particular time/date window or at particular location until the user types out “Mary S.”

### EXAMPLE 5

In yet another example of the utility of the invention, a group of four friends—Al, Bob, Charlie and Dave—are traveling together. Each subscribes to a common location-reporting service and each has his contact information stored (or mirrored) on a remote server.

Using the method of the invention, Bob's smartphone may determine that Al, Charlie and Dave are generally moving along with Bob and therefore categorize them as travelling companions. The smartphones of Al, Charlie and Dave may do likewise. The system may determine that the travelling companions mostly have access to each other's contact data except for Al and Dave. In response, the system may display a notification asking whether Al and Dave want to exchange contact information. Either user can choose to decline, or if both accept, their information may be added to each other's device.

### EXAMPLE 6

In this example, the device has access (e.g. via a location-sharing service) to information concerning the current location of certain contacts in the user's list of contacts. If for example both the user and contact “Mark” are most often in the Los Angeles basin, the method may prioritize the contact information for “Mark” if it is determined that both the user and Mark are simultaneously in the same, remote location (e.g., Lake Tahoe).

### EXAMPLE 7

While many of the preceding examples have concerned telephone numbers, the method of the present invention may be applied to other elements of contact information such as text messages, e-mail addresses, driving directions and the like.

By way of example, a user might frequently drive to someone's home address outside of work hours, but never to their work address during that time. If the user requests driving directions on a weekend evening, the home address may be (initially) displayed for user selection. However, if driving directions were requested on a weekday at 2:00 p.m., both addresses for that contact may be displayed for user selection.

Although particular embodiments of the present invention have been shown and described, they are not intended to limit what this patent covers. One skilled in the art will understand that various changes and modifications may be made without departing from the scope of the present invention as literally and equivalently covered by the following claims.

What is claimed is:

1. A method for prioritizing a list of contacts on a portable processor-based device comprising:
assigning priority to a contact based at least in part on the frequency of selection of the contact; and,
adjusting the assigned priority of the contact based on a factor selected from the group of factors consisting of the location of the portable processor-based device, the time of day, the day of the week, the recency of selection of the contact, the recency of an in-coming call from the contact, the frequency of in-coming calls from the contact, and the recency of non-telephonic communication via the device with the contact.

2. A method as recited in claim 1 wherein the contact comprises a name and at least one alphanumeric selected from the group consisting of telephone numbers, e-mail addresses, network addresses, IM addresses and social media addresses.

3. A method as recited in claim 1 wherein the prioritized contact is comprised of a name and a single telephone number.

4. A method as recited in claim 1 wherein the portable processor-based device comprises a location sensor that is selected from the group consisting of global navigation satellite system receivers, cellular telephone transceivers, Wi-Fi transceivers and assisted GPS receivers and the location of the portable processor-based device is determined from data output by the location sensor.

5. A method for prioritizing a list of contacts on a portable processor-based device comprising:
assigning priority to a contact based at least in part on the current location of the portable processor-based device.

6. A method as recited in claim 5 wherein the portable processor-based device comprises a location sensor selected from the group consisting of global navigation satellite system receivers, cellular telephone transceivers, Wi-Fi transceivers and assisted GPS receivers and the current location of the portable processor-based device is determined by data from the location sensor.

7. A method as recited in claim 5 further comprising adjusting the priority of the contact based on the frequency of selection of the contact.

8. A method as recited in claim 5 further comprising adjusting the assigned priority of the contact based at least in part on historical data concerning communication with the contact via the device other than the frequency of selection of the contact.

9. A method as recited in claim 8 wherein the historical data is selected from the group consisting of the time of day of previous communication with the contact, the day of the week of previous communication with the contact, the recency of selection of the contact, the recency of an in-coming call from the contact, the frequency of in-coming calls from the contact, and the recency of non-telephonic communication via the device with the contact.

10. A method as recited in claim 5 wherein the display of at least one contact in a displayed list of contacts on a portable processor-based device is suppressed based at least in part on the current location of the portable processor-based device.

11. A method as recited in claim 10 further comprising suppressing the display of the contact based additionally upon the time of day.

12. A method as recited in claim 10 further comprising suppressing the display of the contact based additionally upon the day of the week.

13. A method as recited in claim 10 further comprising suppressing the display of the contact based additionally upon the time of day and the day of the week.

14. A method as recited in claim 10 further comprising suppressing the display of the contact based additionally upon the type of contact.

15. A method of adding entries to a contact database comprising:
determining whether a first portable processor-based device is moving in concert with a second portable processor-based device;
prompting the user of the first portable processor-based device to enable sharing of contact information associated with the first portable processor-based device with the user of the second portable processor-based device via a data network.

16. A method as recited in claim 15 wherein the first portable processor-based device and the second portable processor-based device each comprise a location sensor that is selected from the group consisting of global navigation satellite system receivers, cellular telephone transceivers, Wi-Fi transceivers and assisted GPS receivers and the location of each portable processor-based device is determined from data output by its location sensor.

17. A method as recited in claim 15 wherein determining whether a first portable processor-based device is moving in concert with a second portable processor-based device includes determining the distances moved by the first and second portable processor-based devices and the length of time of the movements.

18. A portable processor-based system comprising:
a processor;
at least one sensor responsive to location and in data communication with the processor; and,
a memory storing instructions for causing the processor to
assign priority to a contact in a list of contacts based at least in part on the frequency of selection of the contact; and,
adjust the assigned priority of the contact based on a factor selected from the group of factors consisting of the location of the portable processor-based device, the time of day, the day of the week, the recency of selection of the contact, the recency of an in-coming call from the contact, the frequency of in-coming calls from the contact, and the recency of non-telephonic communication via the device with the contact.

19. A portable processor-based system as recited in claim 18 wherein the contact comprises a name and at least one alphanumeric selected from the group consisting of telephone numbers, e-mail addresses, network addresses, IM addresses and social media addresses.

20. A portable processor-based system as recited in claim 18 wherein the prioritized contact is comprised of a name and a single telephone number.

21. A portable processor-based system as recited in claim 18 wherein the portable processor-based device comprises a location sensor that is selected from the group consisting of global navigation satellite system receivers, cellular telephone transceivers, Wi-Fi transceivers and assisted GPS receivers and the location of the portable processor-based device is determined from data output by the location sensor.

22. A computer-readable medium comprising instructions for prioritizing a list of contacts on a portable processor-based device by performing the steps of:
receiving data from at least one sensor responsive to location of the portable processor-based device;
assigning priority to a contact based at least in part on the frequency of selection of the contact; and,
adjusting the assigned priority of the contact based on a factor selected from the group of factors consisting of the location of the portable processor-based device, the time of day, the day of the week, the recency of selection of the contact, the recency of an in-coming call from the contact, the frequency of in-coming calls from the contact, and the recency of non-telephonic communication via the device with the contact.

23. A computer-readable medium as recited in claim 22 wherein the contact comprises a name and at least one alphanumeric selected from the group consisting of telephone numbers, e-mail addresses, network addresses, IM addresses and social media addresses.

24. A computer-readable medium as recited in claim 22 wherein the prioritized contact is comprised of a name and a single telephone number.

25. A computer-readable medium as recited in claim 22 wherein the portable processor-based device comprises a location sensor that is selected from the group consisting of global navigation satellite system receivers, cellular telephone transceivers, Wi-Fi transceivers and assisted GPS receivers and the location of the portable processor-based device is determined from data output by the location sensor.
